(19) United States
(12) Patent Application Publication
(10) Pub. No.: US 2003/0067927 A1
(43) Pub. Date: Apr. 10, 2003

(54) Provisioning a media terminal adapter

(75) Inventors: Ajit Nair, Framingham, MA (US); Edwige Jean-Baptiste, Shrewsbury, MA (US)

Correspondence Address: Fogg, Slifer & Polglaze, P.A., P.O. Box 581009, Minneapolis, MN, 55458-1009, US

(73) Assignee: ADC Telecommunications, Inc.

(21) Appl. No.: 09/972,069

(22) Filed: Oct. 5, 2001

(51) Int. Cl. H04L 12/28

(52) U.S. Cl. 370/401; 370/389

(57) ABSTRACT

A method of dynamic host configuration is provided. The method includes receiving a provisioning request from a media terminal adapter including an identifier, selecting a service provider designated Internet Protocol address for providing telephony service through the media terminal adapter, and generating a unique fully qualified domain name for the media terminal adapter based on the identifier. The method further includes transmitting the unique fully qualified domain name and Internet Protocol address to the media terminal adapter, receiving a provisioning acceptance notice from the media terminal adapter, and providing configuration information to the media terminal adapter including the selected fully qualified domain name and the selected internet protocol address. In another method, a domain name server stores the Internet Protocol address and fully qualified domain name in order to support look-ups based on either the Internet Protocol address or the fully qualified domain name.

### TECHNICAL FIELD

The present invention relates generally to the field of telecommunications and, in particular, to provisioning a media terminal adapter (MTA).

### BACKGROUND

Coaxial cable networks have been used to deliver high quality video programming to subscribers for many years. Conventionally, these networks have been unidirectional, broadcast networks with a limited number of channels and a limited variety of content provided to the subscribers. In recent years, cable companies have developed systems to provide bi-directional communication over their existing networks to provide a wider variety of services and content to their subscribers. For example, many cable companies now provide connection to the Internet through the use of cable modems.

The cable industry has developed a number of standards for delivering data over their networks to provide a uniform basis for the design and development of the equipment necessary to support these services. For example, a consortium of cable companies developed the Data Over Cable Service Interface Specifications (DOCSIS) standard. The DOCSIS standard specifies the necessary interfaces to allow for transparent, bi-directional transfer of Internet Protocol (IP) traffic between a cable head end and customer equipment over a cable or hybrid fiber/coax network.

Some cable companies are beginning to offer telephony service over their cable networks. This same consortium of companies, known as CableLabs, has developed a standard for delivering telephony service using Internet Protocol (IP) data packets over a cable network; so-called voice over IP (VoIP) traffic. This standard is known as the PacketCable standard and is described in a plurality of related specifications. To date, CableLabs has released specifications for PacketCable 1.0, PacketCable 1.1, and PacketCable 1.2.

To implement telephony service over a cable network, the PacketCable standard requires a media terminal adapter (MTA) to be connected with the cable modem. The media terminal adapter includes an interface to a physical voice device, e.g., a telephone. Additionally, the MTA includes a network interface, CODECs, and other circuitry necessary for processing telephony signals and IP packets. Further, the PacketCable standard also requires that the MTA is addressable by both an IP address and a fully qualified domain name (FQDN). These are provided to the MTA when provisioned on boot-up. The Packet Cable standard requires that the FQDN is unique but is silent on how to create unique FQDNs. In providing telephony service, various lookups are required based on IP address and based on FQDNs.

For the reasons stated above, and for other reasons stated below which will become apparent to those skilled in the art upon reading and understanding the present specification, there is a need in the art for a technique for generating unique fully qualified domain names for media terminal adapters.

### SUMMARY

The above mentioned problems with addressing media terminal adapters for voice over IP (VoIP) service and other problems are addressed by embodiments of the present invention and will be understood by reading and studying the following specification. Specifically, embodiments of the present invention provide for generating a fully qualified domain name for a media terminal adapter using a MAC address and a domain name selected by service provider. Advantageously, the MAC address is unique to the host and thus the combination of the MAC address and the domain name provide an acceptable fully qualified domain name.

A method of dynamic host configuration is provided. The method includes receiving a provisioning request from a media terminal adapter including an identifier, selecting a service provider designated Internet Protocol address for providing telephony service through the media terminal adapter, and generating a unique fully qualified domain name for the media terminal adapter based on the identifier. The method further includes transmitting the unique fully qualified domain name and Internet Protocol address to the media terminal adapter, receiving a provisioning acceptance notice from the media terminal adapter, and providing configuration information to the media terminal adapter including the selected fully qualified domain name and the selected internet protocol address.

In another embodiment, a method of provisioning a media terminal adapter is provided. The method includes transmitting from one or more dynamic host configuration protocol servers a dynamic host configuration protocol offer in response to a dynamic host configuration protocol discover message and receiving the dynamic host configuration protocol offers from the one or more dynamic host configuration protocol servers. Each received dynamic host configuration protocol offer includes a unique fully qualified domain name and an Internet Protocol address based on an identifier provided with the dynamic host configuration protocol discover message. The method further includes selecting one of the one or more the dynamic host configuration protocol offers from one of the one or more dynamic host configuration protocol servers, and receiving configuration information from the selected one of the one or more dynamic host configuration protocol servers. The configuration information includes the unique fully qualified domain name and the Internet Protocol address.

In another embodiment, a communication system is provided. The communication system includes a cable modem termination system, an access network coupled to the cable modem termination system, at least one media terminal adapter communicatively coupled to the cable modem termination system over the access network, and a dynamic host configuration protocol server adapted to select a service provider designated Internet Protocol address for providing telephony service through the at least one media terminal adapter and to generate a unique fully qualified domain name for the at least one media terminal adapter based on an identifier provided by the media terminal adapter.

### BRIEF DESCRIPTION OF THE DRAWINGS

FIG. 1 is a block diagram of one embodiment of a communication network according to the teachings of the present invention.

FIG. 2 is a block diagram of one embodiment of a fully qualified domain name for a media terminal adapter according to the teachings of the present invention.

FIG. 3 is a flow chart of a process for provisioning a media terminal adapter (MTA) according to the teachings of the present invention.

FIG. 4 is a flow chart of one embodiment of a process for a dynamic host configuration protocol (DHCP) to provision a media terminal adapter according to the teachings of the present invention.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present invention, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention address problems with generating unique fully qualified domain names for media terminal adapters so that voice over IP traffic may be carried over a cable network. Advantageously, the fully qualified domain names are generated by simply concatenating a media access control (MAC) address with a domain name selected by service provider. This information is provided to the media terminal adapter at boot up during provisioning.

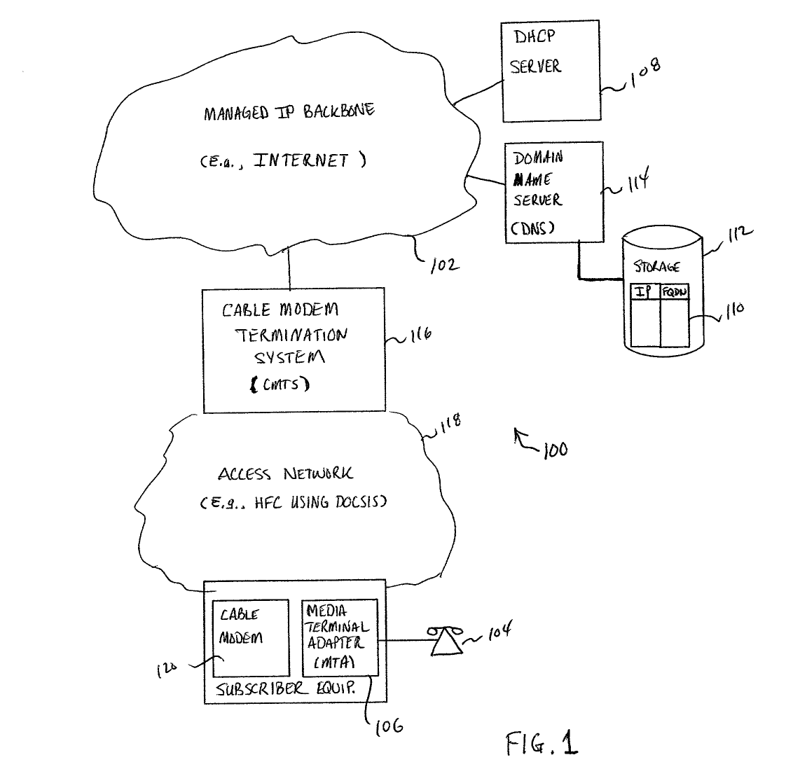

FIG. 1 is a block diagram of one embodiment of a communication network, indicated generally at 100, according to the teachings of the present invention. Network 100 provides for voice over IP (VoIP) traffic to be transported to and from a physical voice device, e.g., telephone 104, over a managed IP backbone network 102, e.g., the Internet, a cable modem termination system (CMTS) 116 and an access network 118, e.g., a hybrid fiber/coax (HFC) network.

Network 100 also includes various communication modules that are used to configure and track the configuration of cable modems in network 100. For example, network 100 includes at least one dynamic host configuration protocol (DHCP) server 108 for provisioning or configuring cable modems and other communication devices for communication over the network. The DHCP server 108 conforms to RFC 2131, RFC 2132 and other appropriate standards and RFCs for configuring communication devices. Further, network 100 also includes domain name server (DNS) 114. Domain name server 114 stores addressing information for various communication devices in network 100 as described more fully below.

At the subscriber location, the physical voice device 104 interfaces with network 100 through media terminal adapter (MTA) 106 and cable modem 120. DHCP server 108 provisions MTA 106 with an IP address and a fully qualified domain name (FQDN) at boot up. The IP address and its associated FQDN for MTA 106 are stored in table 110 of storage 112 of domain name server (DNS) 114. Thus, DNS 114 provides a mapping between IP address and FQDN. This allows network 100 to deliver VoIP service according to the PacketCable standard because DNS 114 supports look-ups based on either the IP address or the FQDN.

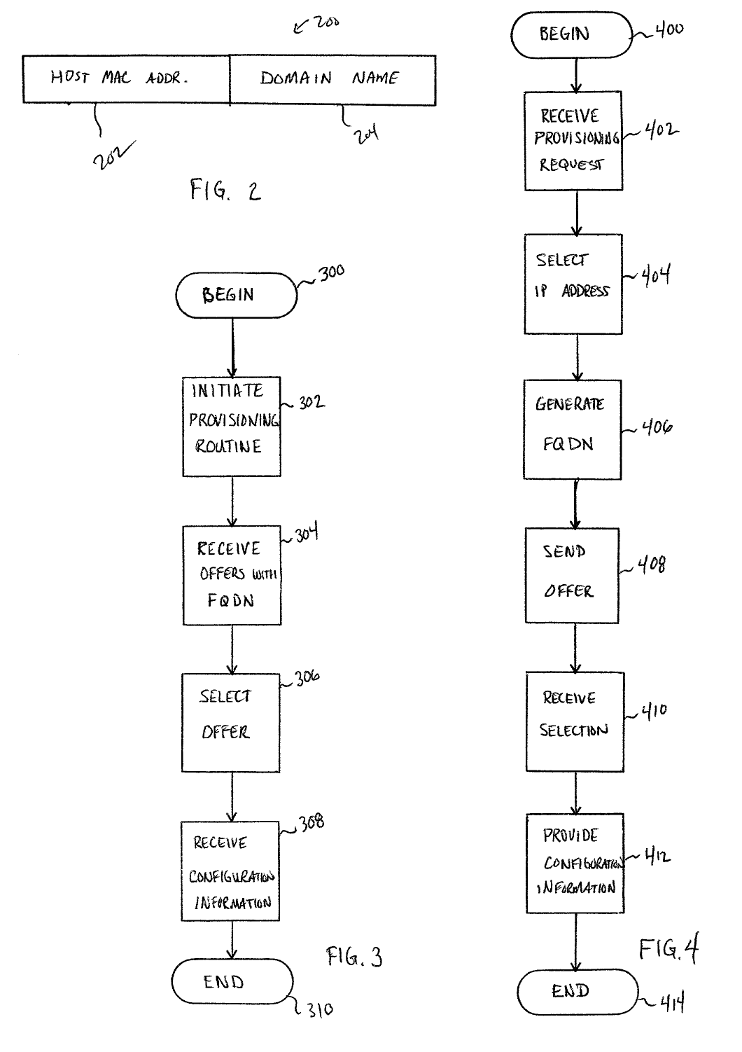

Advantageously, network 100 supports provisioning MTA 106 with an FQDN and a dynamic IP address. One embodiment of an FQDN, indicated generally at 200, is shown in FIG. 2. The FQDN includes two main components. The first component is the host name. In one embodiment, the host name is the MAC address 202 of the MTA. The second component is a domain name 204 selected by the service provider that is providing VoIP services over network 100. Thus, FQDN 200 is:

{Host MAC Address}.{Domain Name}

In one embodiment, this FQDN is stored in storage 112 of DNS 114.

One embodiment of the operation of provisioning MTA 106 is described with respect to FIGS. 3 and 4. The method of FIG. 3 describes the process as performed by media terminal adapter 106. The method of FIG. 4 describes the process as performed by DHCP server 108. Each of these processes is described in turn below.

FIG. 3 is a flow chart of a process for provisioning a media terminal adapter (MTA) according to the teachings of the present invention. The method begins at block 300. At block 302, MTA 106 initiates a provisioning routine. In one embodiment, MTA 106 generates a DHCP discover message and transmits the message over access network 118 to a managed IP backbone 102. This message is received and responded to by one or more DHCP servers, e.g., including DHCP server 108. In one embodiment, DHCP server 108 generates a DHCP offer that is received at block 304 by MTA 106. The received offers each include a fully qualified domain name based on the MAC address of MTA 106 and an IP address.

At block 306, MTA 106 selects an offer from one of the DHCP servers. In one embodiment, MTA 106 communicates the acceptance to DHCP server 108 through a DHCP request message. Finally, at block 308, MTA 106 receives configuration information from DHCP server 108, including the fully qualified domain name and the IP address. The method ends at block 310.

FIG. 4 is a flow chart of one embodiment of a process for a dynamic host configuration protocol (DHCP) to provision a media terminal adapter according to the teachings of the present invention. The method begins at block 400. At block 402, the method receives a provisioning request from MTA 106, e.g., a DHCP discover message. At block 404, DHCP server 108 selects an IP address from a pool of IP addresses designated by the service provider for providing telephony service through an MTA. Further, at block 406, DHCP server 108 generates a fully qualified domain name for the MTA. The fully qualified domain name and IP address are inserted into an offer and sent to MTA 106 at block 408.

After MTA 106 selects an offer, the selection is communicated to all DHCP servers responding to the provisioning request. The selection, in one embodiment, is indicated through a DHCP request message. At block 410, DHCP server 108 receives a DHCP request message. At block 412, DHCP server 108 provides configuration information to MTA 106, including, the selected fully qualified domain name and the selected IP address. Additionally, DHCP server 108 provides the IP address and corresponding fully qualified domain name to domain name server 114. The IP address and fully qualified domain name form a data pair. This pair of data is also stored in table 110 of storage 112 to allow subsequent lookups based on either IP address or fully qualified domain name to retrieve the corresponding element in the pair. The method ends at block 414.

Although specific embodiments have been illustrated and described herein, it will be appreciated by those of ordinary skill in the art that any arrangement, which is calculated to achieve the same purpose, may be substituted for the specific embodiments shown. For example, in other embodiments, other appropriate values could be used in place of the MAC address for the host portion of the fully qualified domain name. For example, a name generator function could be included in the DHCP server to generate names as needed for provisioning MTAs. This application is intended to cover any adaptations or variations of the present invention. Therefore, it is intended that this invention be limited only by the claims and the equivalents thereof.

What is claimed is:

1. A method of dynamic host configuration, comprising:
receiving a provisioning request from a media terminal adapter including an identifier;
selecting a service provider designated Internet Protocol address for providing telephony service through the media terminal adapter;
generating a unique fully qualified domain name for the media terminal adapter based on the identifier;
transmitting the unique fully qualified domain name and Internet Protocol address to the media terminal adapter;
receiving a provisioning acceptance notice from the media terminal adapter; and
providing configuration information to the media terminal adapter including the selected fully qualified domain name and the selected internet protocol address.

2. The method of claim 1, further comprising providing the unique fully qualified domain name and corresponding Internet Protocol address as a data pair to an associated domain name server.

3. The method of claim 1, wherein generating a unique fully qualified domain name based on the identifier comprises generating a unique fully qualified domain name based on a media access control address of the media terminal adapter and a service provider selected domain name.

4. The method of claim 1, wherein receiving a provisioning request from a media terminal adapter comprises receiving a dynamic host configuration protocol discover message from a media terminal adapter.

5. The method of claim 1, wherein transmitting the unique fully qualified domain name and Internet Protocol address to the media terminal adapter comprises transmitting the unique fully qualified domain name and Internet Protocol address via a dynamic host configuration protocol request message to the media terminal adapter.

6. The method of claim 1, further comprising storing the unique fully qualified domain name and corresponding Internet Protocol address as a data pair, wherein the data pair is subsequently retrievable based on either the Internet Protocol address or unique fully qualified domain name.

7. The method of claim 2, further comprising storing the data pair wherein the data pair is subsequently retrievable based on either the Internet Protocol address or unique fully qualified domain name.

8. A method of provisioning a media terminal adapter, comprising:
transmitting from one or more dynamic host configuration protocol servers a dynamic host configuration protocol offer in response to a dynamic host configuration protocol discover message;
receiving the dynamic host configuration protocol offers from the one or more dynamic host configuration protocol servers, wherein each received dynamic host configuration protocol offer includes a unique fully qualified domain name and an Internet Protocol address based on an identifier provided with the dynamic host configuration protocol discover message;
selecting one of the one or more the dynamic host configuration protocol offers from one of the one or more dynamic host configuration protocol servers; and
receiving configuration information from the selected one of the one or more dynamic host configuration protocol servers, wherein the configuration information includes the unique fully qualified domain name and the Internet Protocol address.

9. The method of claim 8, wherein selecting the dynamic host configuration protocol offer from one of the one or more dynamic host configuration protocol servers comprises transmitting a dynamic host configuration protocol request message to one of the one or more dynamic host configuration protocol servers.

10. The method of claim 8, wherein each received dynamic host configuration protocol offer includes a unique fully qualified domain name based on the media access control address of the media terminal adapter and a service provider selected domain name.

11. A method of provisioning a media terminal adapter, comprising:
initiating a provisioning routine;
transmitting an initiating message including an identifier;
transmitting from one or more dynamic host configuration protocol servers a dynamic host configuration protocol offer in response to the initiated message; and
receiving one or more dynamic host configuration protocol offers in response to the initiated message, wherein each received dynamic host configuration protocol offer includes a unique fully qualified domain name based on the identifier and an Internet Protocol address;
selecting a dynamic host configuration protocol offer from the one or more dynamic host configuration protocol offers; and
receiving configuration information based on the selected dynamic host configuration protocol offer, wherein the configuration information includes the unique fully qualified domain name and the Internet Protocol address.

12. The method of claim 11, wherein transmitting an initiating message comprises transmitting a dynamic host configuration protocol discover message.

13. The method of claim 11, wherein selecting a dynamic host configuration protocol offer from the one or more dynamic host configuration protocol offers comprises transmitting a dynamic host configuration protocol request message in response to one of the one or more dynamic host configuration protocol offers.

14. The method of claim 11, wherein each received dynamic host configuration protocol offer includes a unique fully qualified domain name based on the media access control address of the media terminal adapter and an Internet Protocol address.

15. A computer-usable medium having computer readable instructions stored thereon for execution by a processor to perform a method comprising:
initiating a provisioning routine;
transmitting an initiating message including an identifier;
transmitting from one or more dynamic host configuration protocol servers a dynamic host configuration protocol offer in response to the initiated message; and
receiving one or more dynamic host configuration protocol offers in response to the initiated message, wherein each received dynamic host configuration protocol offer includes a unique fully qualified domain name based on the identifier and an Internet Protocol address;
selecting a dynamic host configuration protocol offer from the one or more dynamic host configuration protocol offers; and
receiving configuration information based on the selected dynamic host configuration protocol offer, wherein the configuration information includes the unique fully qualified domain name and the Internet Protocol address.

16. The method of claim 15, wherein transmitting an initiating message comprises transmitting a dynamic host configuration protocol discover message.

17. The method of claim 15, wherein selecting a dynamic host configuration protocol offer from the one or more dynamic host configuration protocol offers comprises transmitting a dynamic host configuration protocol request message in response to one of the one or more dynamic host configuration protocol offers.

18. The method of claim 15, wherein each received dynamic host configuration protocol offer includes a unique fully qualified domain name based on the media access control address of the media terminal adapter and an Internet Protocol address.

19. A computer-usable medium having computer readable instructions stored thereon for execution by a processor to perform a method, comprising:
transmitting from one or more dynamic host configuration protocol servers a dynamic host configuration protocol offer in response to a dynamic host configuration protocol discover message;
receiving the dynamic host configuration protocol offer from the one or more dynamic host configuration protocol servers, wherein each received dynamic host configuration protocol offer includes a unique fully qualified domain name and an Internet Protocol address based on an identifier provided by the media terminal adapter;
selecting the dynamic host configuration protocol offer from one of the one or more dynamic host configuration protocol servers; and
receiving configuration information from the selected one of the one or more dynamic host configuration protocol servers, wherein the configuration information includes the unique fully qualified domain name and the Internet Protocol address.

20. The method of claim 19, wherein selecting the dynamic host configuration protocol offer from one of the one or more dynamic host configuration protocol servers comprises transmitting a dynamic host configuration protocol request message to one of the one or more dynamic host configuration protocol servers.

21. The method of claim 19, wherein each received dynamic host configuration protocol offer includes a unique fully qualified domain name based on the media access control address of the media terminal adapter and a service provider selected domain name.

22. A communication system, comprising:
a cable modem termination system;
an access network coupled to the cable modem termination system;
at least one media terminal adapter communicatively coupled to the cable modem termination system over the access network; and
a dynamic host configuration protocol server adapted to select a service provider designated Internet Protocol address for providing telephony service through the at least one media terminal adapter and to generate a unique fully qualified domain name for the at least one media terminal adapter based on an identifier provided by the media terminal adapter.

23. The system of claim 22, further comprising a domain name server adapted to provide a mapping between the Internet Protocol address and the unique fully qualified domain name.

24. The system of claim 22, wherein the access network is a hybrid fiber/coax network utilizing DOCSIS.

25. The system of claim 23, wherein the domain name server supports look-ups based on either the Internet Protocol address or the unique fully qualified domain name to retrieve the corresponding element in the pair.

26. The system of claim 22, further comprising a physical voice device adapted to interface with the access network through the media terminal adapter and a cable modem.

27. The system of claim 23, further comprising a storage device associated with the domain name server.

28. The system of claim 22, wherein the identifier comprises the media terminal adapter's media access control address.

29. A communication system, comprising:
subscriber equipment adapted to interface a physical voice device with an access network, including:
a cable modem; and
a media terminal adapter;
a plurality of dynamic host configuration protocol servers adapted to provision the media terminal adapter with an Internet Protocol address and a fully qualified domain name based on an identifier provided by the media terminal adapter; and
a domain name server adapted to store the Internet Protocol address and fully qualified domain name and to support look-ups based on either the Internet Protocol address or the fully qualified domain name.

30. The system of claim 29, wherein the access network is a hybrid fiber/coax network utilizing DOCSIS.

31. The system of claim 29, further comprising a storage device associated with the domain name server.

32. The system of claim 29, wherein the identifier comprises the media terminal adapter's media access control address.

33. The system of claim 29, further comprising a cable modem termination system adapted to interface with the subscriber equipment via the access network and the plurality of dynamic host configuration protocol servers via a managed Internet Protocol backbone.
